(19) United States
(12) Patent Application Publication
(10) Pub. No.: US 2015/0251134 A1
(43) Pub. Date: Sep. 10, 2015

(54) METHODS AND APPARATUSES FOR REMOVING IMPURITIES FROM A GASEOUS STREAM

(71) Applicant: UOP LLC, Des Plaines, IL (US)

(72) Inventors: Saadet Ulas Acikgoz, Des Plaines, IL (US); George K. Xomeritakis, Wheeling, IL (US); Lubo Zhou, Inverness, IL (US)

(73) Assignee: UOP LLC, Des Plaines, IL (US)

(21) Appl. No.: 14/202,770

(22) Filed: Mar. 10, 2014

(51) Int. Cl. B01D 53/62; B01D 53/52

(52) U.S. Cl. CPC B01D 53/62; B01D 53/52

(57) ABSTRACT

Methods and apparatuses are provided for removing impurities from a gas. A method includes feeding a gaseous stream through a vapor side of a first membrane contactor, and then feeding the gaseous stream through the vapor side of a second membrane contactor. An absorption solution is fed through an absorption side of the second membrane contactor, and then fed through an absorption side of the first membrane contactor. The absorption solution is cooled between the second membrane contactor and the first membrane contactor.

### FIELD OF THE INVENTION

The present disclosure generally relates to methods and apparatuses for removing impurities from gaseous streams, and more particularly relates to methods and apparatuses for removing impurities from gaseous streams using porous membranes.

### BACKGROUND

Natural gas often includes carbon dioxide in large concentrations when extracted from a well, and the carbon dioxide content of the natural gas can reach concentrations of about 50 mass percent or more. Carbon dioxide is corrosive and non-combustible, so it is not desired in the natural gas. Some natural gas pipelines establish a maximum carbon dioxide concentration of about 2 mass percent or less. Natural gas used for liquefaction frequently has a carbon dioxide concentration limit of about 50 parts per million by mass or less, because higher concentrations will form dry ice deposits as the natural gas is liquefied. Carbon dioxide is frequently removed from natural gas with an aqueous amine solution, where the carbon dioxide reacts with the amine but not with the hydrocarbons in the natural gas. Typically, the natural gas stream is passed upwards through a packed bed while the amine solution flows downward. The amine solution is then regenerated and re-used.

The amine solution must pass through the packed bed at a sufficient flow rate to absorb the carbon dioxide, and the packed bed, the pumps, and the regenerator are sized for the amount of carbon dioxide to be removed. Many off-shore facilities will rock and move with wave and wind action, and the motion temporarily tilts the packed bed. The efficiency of the packed bed is reduced when tilted because the amine solution accumulates on the lower side of the packed bed while the natural gas moves more rapidly through the upper side of the packed bed due to the reduced flow resistance from the decreased amine solution flow. On many off-shore facilities, the packed bed, amine solution pumps, and related equipment are oversized to account for the motion of the facility. The increased sizes of the packed bed and pump increases the capital expense to build and install the packed bed, and also increases the operating expense to recirculate the amine solution.

Membrane absorbers have been proposed to remove carbon dioxide from natural gas or other vapor streams, where the membrane is frequently in the shape of a tube. Unlike a packed bed, the membrane absorbers have a gas and a liquid amine solution flowing on different sides of the membrane, where the liquid amine solution fills one side of the absorber. As such, the motion of an off-shore facility does not significantly change the operating efficiency and the membrane absorbers do not have to be oversized for the desired service. Many membrane absorbers include porous, polymeric tubes that allow carbon dioxide to pass through the pores of the tubes. The carbon dioxide readily reacts with the amine solution after passing through the pores and is thus extracted from the natural gas. The hydrocarbons do not react with the amine solution, so they do not readily pass through the tubes. However, the reaction of carbon dioxide with amines is exothermic, so the temperature of the amine solution increases as carbon dioxide is absorbed. Many of the polymers used in the tubes will soften at elevated temperatures, so the hot amine solution weakens the tubes and can result in ruptures or bulges. Additionally, colder solutions have a higher carbon dioxide carrying capacity, so less amine solution recirculation is required.

Accordingly, it is desirable to develop methods and apparatuses for removing impurities such as carbon dioxide from natural gas using membrane absorbers while limiting the temperature in the absorbers to maintain integrity of the absorber membrane. In addition, it is desirable to develop methods and apparatuses for removing impurities from natural gas using membrane absorbers with reduced absorber solution recirculation flow rates. Furthermore, other desirable features and characteristics of the present embodiment will become apparent from the subsequent detailed description and the appended claims, taken in conjunction with the accompanying drawings and this background.

### SUMMARY OF THE INVENTION

Methods and apparatuses for removing impurities from gaseous streams are provided. In an exemplary embodiment, a method includes feeding a gaseous stream through a vapor side of a first membrane contactor, and then feeding the gaseous stream through the vapor side of a second membrane contactor. An absorption solution is fed through an absorption side of the second membrane contactor, and then fed through an absorption side of the first membrane contactor. The absorption solution is cooled between the second membrane contactor and the first membrane contactor.

In accordance with another exemplary embodiment, a method for removing impurities from a gas is provided. Impurities are absorbed from a gaseous stream into an absorption solution in a first membrane contactor, where the first membrane contactor includes a first membrane and the first membrane includes a porous polymer. A membrane temperature of the first membrane is limited to less than a first membrane softening temperature during the absorption of impurities.

In accordance with a further exemplary embodiment, an apparatus for removing impurities from a gas is provided. The apparatus includes a first membrane contactor with a first membrane, a first gaseous stream inlet, a first gaseous stream outlet, a first absorber solution inlet, and a first absorber solution outlet. The apparatus also includes a second membrane contactor with a second membrane, a second gaseous stream inlet, a second gaseous stream outlet, a second absorber solution inlet, and a second absorber solution outlet, where the first gaseous stream outlet is coupled to the second gaseous stream inlet. An absorption solution heat exchanger is coupled to the second absorber solution outlet and the first absorber solution inlet.

### BRIEF DESCRIPTION OF THE DRAWINGS

The various embodiments will hereinafter be described in conjunction with the following drawing figures, wherein like numerals denote like elements, and wherein:

FIG. 1 is a side sectional view of an exemplary embodiment of a first membrane contactor;

FIG. 2 is a perspective view of a portion of a first membrane with a tubular shape in accordance with an embodiment;

FIG. 3 is a schematic diagram of an exemplary embodiment of an apparatus and method for removing impurities from a gas;

FIG. 4 is a chart illustrating a hypothetical temperature profile of an absorption solution when absorbing impurities from a gas; and

FIG. 5 is a schematic diagram of an alternate exemplary embodiment of an apparatus and method for removing impurities from a gas.

### DETAILED DESCRIPTION

The following detailed description is merely exemplary in nature and is not intended to limit the application and uses of the embodiment described. Furthermore, there is no intention to be bound by any theory presented in the preceding background or the following detailed description.

The various embodiments described herein relate to methods and apparatuses for removing impurities from gaseous streams. Many gaseous streams include carbon dioxide as an impurity, and some also contain hydrogen sulfide or other impurities. An absorption solution, such as an aqueous amine solution, is used to remove the impurities from the gaseous streams, and the impurities may be removed from a variety of different gaseous streams such as oil refineries streams, petrochemical plant streams, natural gas processing plant streams, flue gases, and synthesis gases (also referred to as Syngas). Membrane absorbers can be used, where the gaseous stream passes on one side of a porous membrane while an absorption solution stream, which may be in liquid form, flows across the other side of the porous membrane. The gaseous stream is generally maintained at a slightly higher pressure than the absorption solution stream, so components of the gaseous stream are urged through the pores of the porous membrane and make contact with the absorption solution stream. However, the temperature of the absorption solution stream often increases during the absorption process due to the heat generated by the exothermic reaction of the compounds in the absorption solution with the impurities. The gaseous stream has the highest concentration of impurities when first entering the membrane absorber, so heat production tends to be highest near the gaseous stream inlet. In some embodiments the absorption solution stream may run counter-current to the gaseous stream so the absorption solution is at its highest temperature near the gaseous stream inlet, which is also near the absorption solution outlet. A plurality of membrane contactors are used, and the absorption solution is cooled between some of the membrane contactors, so the porous membranes of the membrane contactors are not overheated. Additionally, cooler absorption solution results in increased absorption efficiency, so lower absorption solution flow rates can be used while matching impurity removal rates of uncooled systems. Lower absorption solution flow rates decrease the size of the required equipment, and the associated capital and operational costs.

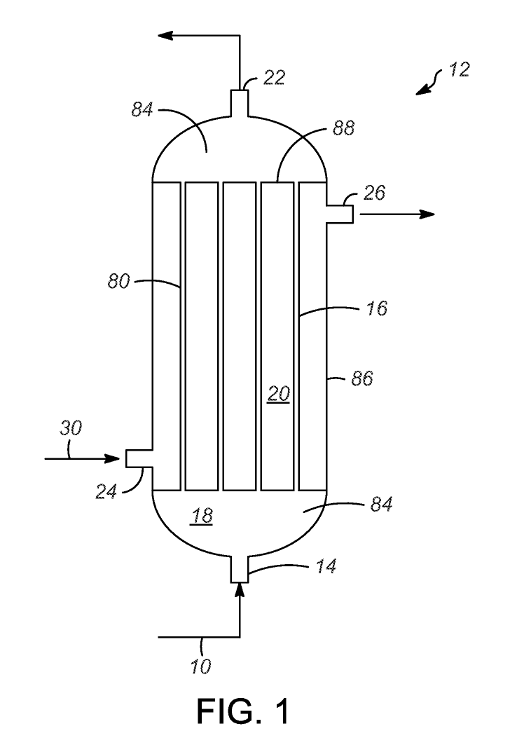

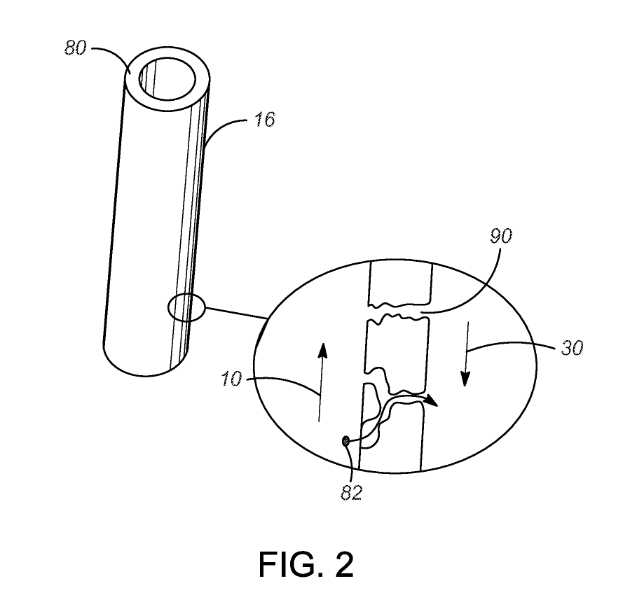

Referring to an exemplary embodiment illustrated in FIGS. 1 and 2, a first membrane contactor 12 is shown. In the exemplary embodiment illustrated, the first membrane contactor 12 includes a first membrane 16 formed from a plurality of tubes 80, and other membrane contactors described herein may have identical or similar designs as the first membrane contactor 12. The tubes 80 are made from a porous material. In many embodiments, the membrane material is polymeric and may include polymers such as polyvinylidenefluoride, polysulfone, polytetrafluoroethylene, polyether ether ketone, other polymeric materials, or combinations thereof The first membrane contactor 12 is designed for impurities to pass from a gaseous stream 10 to an aqueous absorption solution stream 30, and it is preferable if very little or no material passes from the absorption solution stream 30 to the gaseous stream 10. The membrane material may be hydrophobic to help retard penetration of the aqueous absorption solution, which in turn minimizes penetration of components from the absorption solution stream 30. As shown in FIG. 2, the membrane material of the tubes 80 includes a plurality of pores 90 that allow molecules to pass, so a gaseous stream component 82 can pass through the membrane material into the absorption solution stream 30. In one mode of operation, the gaseous stream 10 flows through the center of the tubes 80, the absorption solution stream 30 flows around the outside of the tubes 80, and the gaseous stream component 82 (e.g., impurities in the gaseous stream 10) permeates through the pores 90 of the first membrane 16 into the absorption solution stream 30.

The first membrane 16 divides the first membrane contactor 12 into a vapor side 18 and an absorption side 20. The tubes 80 may be arranged in the first membrane contactor 12 in a design similar to a shell and tube heat exchanger, with a head space 84 at an inlet and an outlet of the tubes 80. As such, the head space 84 and the inner portion of the tubes 80 may form the vapor side 18 of the first membrane contactor 12. A first gaseous stream inlet 14 is fluidly connected to a first gaseous stream outlet 22 through the head spaces 84 and the inner portion of the tubes 80. The first membrane contactor 12 also includes a shell 86. A first absorption solution inlet 24 and a first absorption solution outlet 26 are fluidly connected through the shell and around the outside of the tubes 80. Each tube 80 extends from a tube sheet 88, so the absorption side 20 is within the area formed by the shell 86, the tube sheets 88, and the outside of the tubes 80. In alternate embodiments, the vapor side 18 and absorption side 20 are switched, so the absorption side is within the tubes 80 and vapors flow outside of the tubes 80. In some embodiments, the first absorption solution inlet 24 is lower than the first absorption solution outlet 26, so the liquid absorption solution fills the absorption side 20 during operation. As such, the absorption solution remains in contact with the tubes 80 during sloshing or movement of the first membrane contactor 12. In alternate embodiments (not illustrated), the first membrane 16 may be a sheet or other shapes that divide the first membrane contactor 12 into a vapor side 18 and an absorption side 20. For example, the first membrane 16 may be a sheet that separates a chamber, where the vapor side 18 is one on side of the sheet, and the absorption side 20 is on the other side of the sheet.

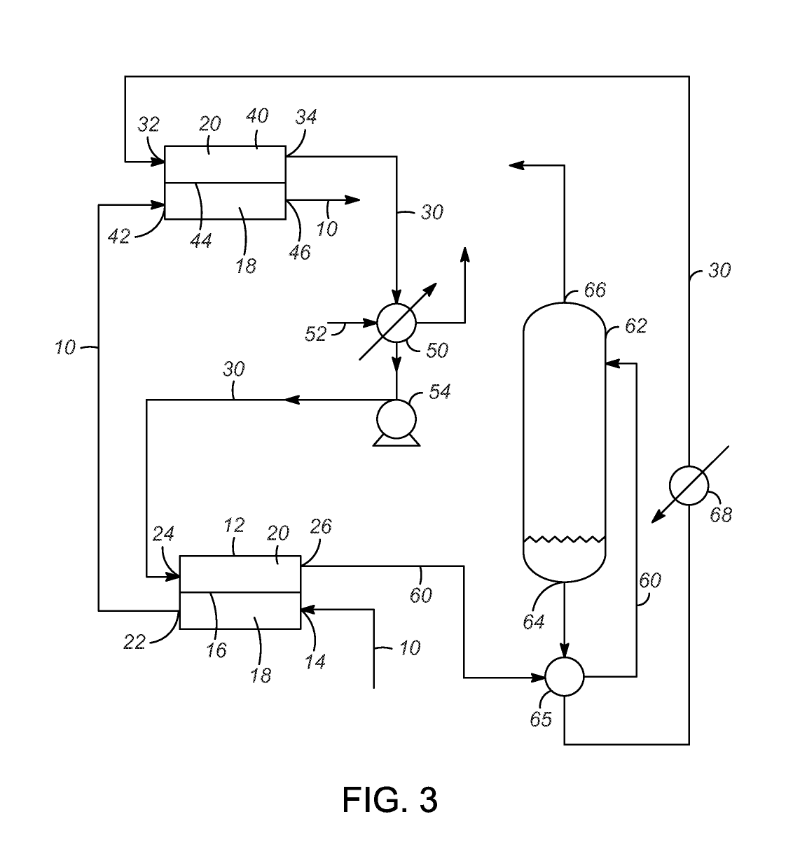

Reference is made to the exemplary embodiment illustrated in FIG. 3. A gaseous stream 10 is treated in a plurality of membrane contactors 12, 40 to remove impurities, such as carbon dioxide and/or hydrogen sulfide. In one embodiment, the gaseous stream 10 is natural gas that includes carbon dioxide, and may include hydrogen sulfide and other impurities. In an exemplary embodiment, the carbon dioxide is lowered to a concentration of about 2 mass percent or less in the membrane contactors 12, 40, and in another embodiment the carbon dioxide is lowered to a concentration of about 50 parts per million by mass or less. In an alternate embodiment, the gaseous stream 10 is a flue gas containing carbon dioxide. In yet another embodiment, the gaseous stream 10 is synthesis gas containing carbon dioxide. In still other embodiments the gaseous stream 10 includes a hydrocarbon and carbon dioxide, such as in an oil refinery or a petrochemical plant. Hydrogen sulfide may also be present in the gaseous stream 10, as well as other impurities.

The gaseous stream 10 is fed into a first membrane contactor 12 at a first gaseous stream inlet 14. The first membrane contactor 12 includes a first membrane 16 that separates the internal portion of the first membrane contactor 12 into a vapor side 18 and an absorption side 20. The gaseous stream 10 exits the first membrane contactor 12 at a first gaseous stream outlet 22. The gaseous stream 10 is then fed into a second gaseous stream inlet 42 of a second membrane contactor 40, so the first gaseous stream outlet 22 is coupled to the second gaseous stream inlet 42. The second membrane contactor 40 includes a second membrane 44 that separates the internal portion into a vapor side 18 and an absorption side 20, and the second membrane contactor 40 is the same or similar to the first membrane contactor 12. The gaseous stream 10 exits the second membrane contactor 40 at a second gaseous stream outlet 46. In some embodiments, the gaseous stream 10 passes through additional membrane contactors (not illustrated) in series, where the size and the number of membrane contactors are designed based on volume of the gaseous stream 10 and the concentration of the impurities. The term “first” and “second” for the first membrane contactor 12 and the second membrane contactor 40 indicate two different membrane contactors, but do not indicate the position of those membrane contactors. Therefore, there may be one or more membrane contactors before the first membrane contactor 12 and/or after the second membrane contactor 40. The gaseous stream 10 may also be split into two or more separate gaseous streams 10 in some embodiments, and each portion of the gaseous stream 10 can pass through a plurality of membrane contactors as described above.

An absorption solution stream 30 is fed into the absorption side 20 of the second membrane contactor 40 at a second absorption solution inlet 32. In an exemplary embodiment, the absorption solution stream 30 includes an aqueous amine solution, where the amine can react with carbon dioxide, hydrogen sulfide, and possibly other impurities.

Many different amines can be used in the absorption solution, such as monoethanol amine, diethanol amine, methyl diethanol amine, triethanol amine, 2 amino 2 methyl 1 propanol, diglycol amine, diisopropanol amine, piperazine, other amines, or combinations thereof. In some embodiments, the amine is present in the absorption solution at a concentration of about 20 to about 50 mass percent, and water is present at a concentration of about 50 to about 80 mass percent. The amine may react and form an ionic bond with the carbon dioxide or hydrogen sulfide, such as:

2RNH₂+CO₂ [symbol] RNH₃⁺+⁻O2CNHR; or

RNH₂+H₂S [symbol] RNH₃⁺+SH⁻

where R is hydrogen or an organic compound.

The reaction of the amine with the carbon dioxide and hydrogen sulfide is reversible, and high temperatures tend to break the ionic bond and form the free amine and gaseous carbon dioxide and/or hydrogen sulfide. Therefore, more impurities can be absorbed by the absorption solution as its temperature drops, and the impurities can be released as a gas by heating the absorption solution stream 30. As such, lower flow rates may be employed for the absorption solution as the temperature of the absorption solution is lowered, and lower flow rates allow for decreased capital and operating costs for the associated equipment.

In the embodiment illustrated in FIG. 3, the absorption solution stream 30 exits the second membrane contactor 40 at a second absorption solution outlet 34, and is fed into an absorption solution heat exchanger 50. A cooling liquid stream 52 is also fed into the absorption solution heat exchanger 50, and the temperature of the absorption solution stream 30 is lowered in the absorption solution heat exchanger 50. The absorption solution heat exchanger 50 may be a shell and tube heat exchanger, a plate and frame heat exchanger, a spiral heat exchanger, or any of a wide variety of other heat exchanger designs known to those skilled in the art. In an alternate embodiment, the absorption solution heat exchanger 50 is air cooled, where a fan blows air over a cooling element (not illustrated.) The temperature of the absorption solution stream 30 is lowered to keep the absorption solution stream 30 below a membrane softening temperature in the first membrane contactor 12. In an exemplary embodiment the temperature is lowered to a point sufficiently low to keep the absorption solution temperature at about 80 degrees centigrade (° C.) or less in the first membrane contactor 12. In some embodiments this may require lowering the temperature of the absorption solution stream 30 to about 60° C. or less before the absorption solution stream 30 enters the first membrane contactor 12, such that the temperature rise from the exothermic absorption of carbon dioxide and other impurities in the first membrane contactor 12 does not increase the absorption solution temperature above about 80° C. The first membrane 16 is generally at about the same temperature as the absorption solution or less.

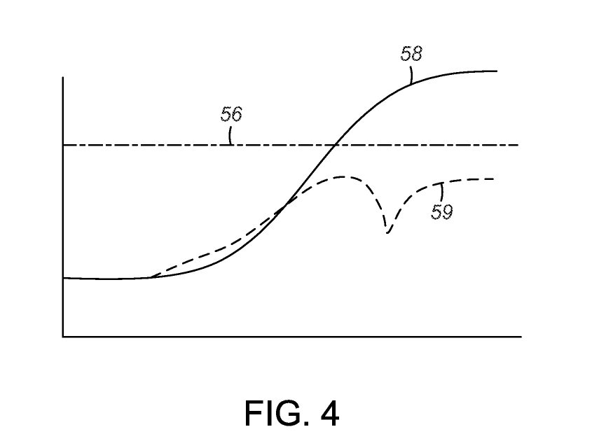

An exemplary absorption solution temperature profile is illustrated in FIG. 4, with continuing reference to FIG. 3. The solid line represents a hypothetical uncooled absorption solution temperature profile 58 for the absorption solution as it passes through a plurality of membrane contactors without any cooling between the membrane contactors, and the horizontal line with alternating long and short dashes represents a membrane softening temperature 56. The first membrane 16, and other membranes in other membrane contactors, may soften when heated to about the membrane softening temperature 56 or above, where the structural integrity or strength of the first membrane 16 decreases to below a design level. In an exemplary embodiment, the membrane softening temperature 56 is about 100° C., but other membrane softening temperatures 56 are possible for varying membrane compositions, designs, and thicknesses. The short dashed line with a dip represents a hypothetical cooled absorption solution temperature profile 59 when the absorption solution passes through the absorption solution heat exchanger 50 between the second and first membrane contactors 40, 12. The gaseous stream 10 has the highest concentration of impurities as it enters the first membrane contactor 12, so there may be a larger temperature rise in the first membrane contactor 12 than in the second or subsequent membrane contactors 40 because more carbon dioxide is available to exothermically react with amines in the absorption solution. The temperature of the absorption solution stream 30 will also be higher at the second absorption solution outlet 34 than at the second absorption solution inlet 32 because of the exothermic reaction in the second membrane contactor 40. Therefore, positioning the absorption solution heat exchanger 50 between the second and first membrane contactors 40, 12 allows for cooling of the absorption solution stream 30 directly before entering the first membrane contactor 12, which would otherwise have the highest absorption solution temperature. In alternate embodiments, there are more than one absorption solution heat exchangers 50 that may be positioned between other successive membrane contactors, or in series between two different membrane contactors.

The absorption solution stream 30 exits the absorption solution heat exchanger 50 and is fed into the first membrane contactor 12. An absorption solution pump 54 may be used to increase the pressure of the absorption solution stream 30 in the first membrane contactor 12. In many embodiments, the pressure of the gaseous stream 10 on the vapor side 18 of a membrane contactor is higher than the pressure of the absorption solution on the absorption side 20 of the membrane contactor such that a membrane pressure differential exists. The membrane pressure differential is limited to within the structural capabilities of the first and second membranes 16, 44. In an exemplary embodiment, the membrane pressure differential is limited to about 1.5 bar of pressure, but other pressure differentials are possible with different membrane materials and designs.

The pressure of the gaseous stream 10 may be somewhat lower in the second membrane contactor 40 than in the first membrane contactor 12 because the second membrane contactor 40 is downstream from the first membrane contactor 12 on the vapor side 18. In some embodiments, the first membrane contactor 12 is downstream from the second membrane contactor 40 on the absorption side 20, which would result in a lower pressure on the absorption side 20 without a pump or other means to increase the pressure. Therefore, in some embodiments, the absorption solution pump 54 is used between membrane absorbers to increase the pressure of the absorption solution stream 30 such that the membrane pressure differential does not exceed the structural capacity of the first and second membranes 16, 44. In other embodiments, there is no absorption solution pump 54, such as when the first membrane 16 has sufficient structural strength to withstand the membrane pressure differential without increasing the pressure on the absorption side 20.

The absorption solution stream 30 enters the first absorption solution inlet 24 of the first membrane contactor 12 after exiting the absorption solution heat exchanger 50 and the absorption solution pump 54, if present. In a hypothetical exemplary embodiment with natural gas as the gaseous stream 10, the pressure on the vapor side 18 of the first and second membrane contactors 12, 40 is about 50 to about 70 bars at a temperature of about 0 to about 50° C. The pressure on the absorption side 20 is about 0.1 to about 2 bars lower than the pressure on the vapor side 18, and the temperature of the absorption solution ranges from about 20 to about 80° C., with the temperature decreasing about 10 to about 25° C. as the absorption solution stream 30 passes through the absorption solution heat exchanger 50. The temperature drop of the absorption solution stream 30 in the absorption solution heat exchanger 50 may be large or smaller in alternate embodiments. In an exemplary embodiment, the first and second membranes 16, 44 are polytetrafluoroethyene tubes with an internal diameter of about 0.5 to about 1.5 millimeters and an outer diameter of about 1 to about 2.5 millimeters. The first and second membranes 16, 44 have a membrane softening temperature of about 100° C. at a membrane pressure differential of about 1.5 bar.

The carbon dioxide concentration in the gaseous stream 10 is reduced from about 5 mass percent to about 50 parts per million by mass or less in a hypothetical model. Based on the analytical model, cooling before the first membrane contactor 12 produces about the same carbon dioxide removal efficiency with a lower absorption solution flow rate. A model predicts cooling the absorption solution stream 30 by about 15° C. before the first absorption solution inlet 24 results in similar carbon dioxide removal efficiency with an absorption solution flow rate about 70 to about 80 percent of the flow rate without the absorption solution heat exchanger 50.

A spent absorption solution stream 60 is discharged from a first absorption solution outlet 26 and is fed into a regenerator 62. The regenerator 62 regenerates the absorption solution, which is discharged from the regenerator bottoms 64. The regenerator 62 heats the absorption solution to a point where the absorbed carbon dioxide, absorbed hydrogen sulfide, and other possible absorbed impurities are released. In an exemplary embodiment, the regenerator 62 boils the aqueous absorption solution, and the carbon dioxide, hydrogen sulfide, and other impurities are discharged as a vapor from a regenerator overhead 66. In an exemplary embodiment, the regenerator 62 operates at about 100 to about 150° C. and a pressure of about 1 to about 3 bars. Water and any amines that are vaporized are condensed and returned to the regenerator 62, and are eventually discharged at the regenerator bottoms 64. The discharge from the regenerator overheads 66 includes carbon dioxide, and may include hydrogen sulfide and other impurities. The hydrogen sulfide may be sent to a sulfur plant for recovery, and the carbon dioxide may be vented to the atmosphere, used for enhanced oil recovery, or otherwise collected and used Amines that may be in the absorption solution can decompose if heated too high, so the temperature of the regenerator 62 can be controlled by limiting the pressure such that the boiling point of the absorption solution is below the decomposition temperature of the amine The absorption solution stream 30, which is discharged from the regenerator bottoms 64, may be cooled in one or more recovery heat exchangers 65 using the spent absorption solution 60 as a coolant. In this optional embodiment, the spent absorption solution 60 is pre-heated by the absorption solution stream 30 before entering the regenerator 62. Air, cooling water, or any available cooling medium can optionally be used to cool the absorption solution stream 30 in one or more regenerator heat exchangers 68. After cooling, the absorption solution stream 30 can be re-used in the membrane contactors.

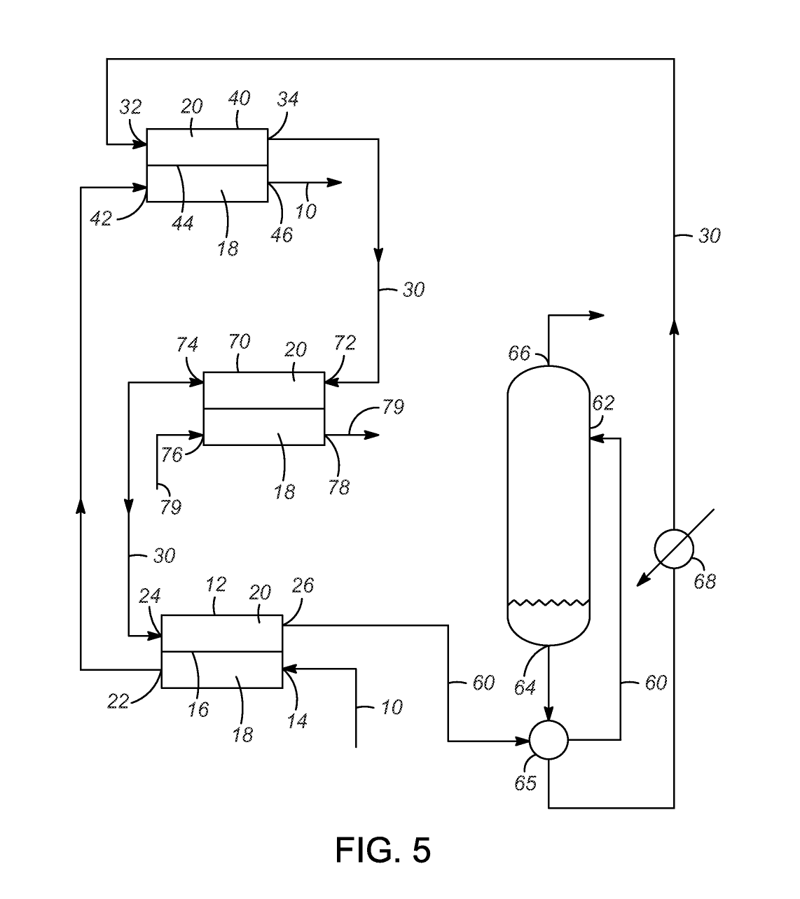

An alternate embodiment is illustrated in FIG. 5, where a third membrane contactor 70 is installed between the first and second membrane contactors 12, 40. In this embodiment, the absorption solution stream 30 passes from the second absorption solution outlet 34 to the third absorption solution inlet 72, flows through the absorption side 20 of the third membrane contactor 70, and exits the third absorption solution outlet 74. A contactor cooling stream 79 enters a third vapor side inlet 76, passes through the vapor side 18 of the third membrane contactor 70, and exits from a third vapor side outlet 78.

The contactor cooling stream 79 cools the absorption solution stream 30 in the third membrane contactor 70 to lower the absorption solution temperature prior to entering the first membrane contactor 12. The absorption solution stream 30 is fed into the first absorption solution inlet 24 after exiting the third membrane contactor 70. The gaseous stream 10 by-passes the third membrane contactor 70. As such, the third membrane contactor 70 serves as a heat exchanger to cool the absorption solution stream 30. The third membrane contactor 70 can be the same or similar to other membrane contactors in use, which can simplify construction and maintenance.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more embodiments, it being understood that various changes may be made in the function and arrangement of elements described in an exemplary embodiment without departing from the scope, as set forth in the appended claims.

1. A method of removing impurities from a gaseous stream, wherein the method comprises:
feeding the gaseous stream through a vapor side of a first membrane contactor;
feeding the gaseous stream through the vapor side of a second membrane contactor after feeding the gaseous stream through the first membrane contactor;
feeding an absorption solution stream through an absorption side of the second membrane contactor;
feeding the absorption solution stream through the absorption side of the first membrane contactor after feeding the absorption solution stream through the second membrane contactor; and
cooling the absorption solution stream between the second membrane contactor and the first membrane contactor.

2. The method of claim 1 wherein feeding the absorption solution stream through the first membrane contactor comprises feeding the absorption solution stream through the first membrane contactor wherein the first membrane contactor comprises a first membrane, and the first membrane comprises a plurality of tubes.

3. The method of claim 1 wherein feeding the absorption solution stream through the absorption side of the first membrane contactor comprises absorbing impurities from the gaseous stream into the absorption solution stream through a first membrane in the first membrane contactor; and
wherein feeding the absorption solution stream through the absorption side of the second membrane contactor comprises absorbing impurities from the gaseous stream into the absorption solution stream through a second membrane in the second membrane contactor.

4. The method of claim 3 wherein absorbing impurities from the gaseous stream into the absorption solution stream through the first membrane in the first membrane contactor and through the second membrane in the second membrane contactor comprises absorbing carbon dioxide from the gaseous stream.

5. The method of claim 3 wherein absorbing impurities from the gaseous stream into the absorption solution stream comprises absorbing hydrogen sulfide from the gaseous stream.

6. The method of claim 1 wherein feeding the absorption solution stream through the second membrane contactor comprises feeding the absorption solution stream through the second membrane contactor wherein the absorption solution stream comprises an aqueous amine solution.

7. The method of claim 1 wherein cooling the absorption solution stream comprises passing the absorption solution stream through an absorption solution heat exchanger while passing a cooling liquid stream through the absorption solution heat exchanger.

8. The method of claim 1 wherein cooling the absorption solution stream comprises passing the absorption solution stream through an air cooled heat exchanger.

9. The method of claim 1 wherein the gaseous stream is a natural gas stream, and wherein feeding the gaseous stream through the first membrane contactor comprises feeding the natural gas stream through the first membrane contactor.

10. The method of claim 1 wherein feeding the gaseous stream through the first membrane contactor comprises feeding the gaseous stream through the first membrane contactor wherein the first membrane contactor comprises a first membrane, and the first membrane comprises a porous polymer.

11. The method of claim 10 wherein feeding the gaseous stream through the first membrane contactor comprises feeding the gaseous stream through the first membrane contactor wherein the first membrane has a softening temperature of about 100 degrees centigrade or less.

12. The method of claim 1 wherein cooling the absorption solution stream comprises feeding a cooling liquid stream through the vapor side of a third membrane contactor; and
feeding the absorption solution stream through the absorption side of the third membrane contactor.

13. The method of claim 1 wherein feeding the absorption solution stream to the first membrane contactor comprises limiting the absorption solution stream to about 80 degrees centigrade or less while in the first membrane contactor.

14. A method of removing impurities from a gaseous stream, wherein the method comprises:
absorbing impurities from a gaseous stream into an absorption solution in a first membrane contactor, wherein the first membrane contactor comprises a first membrane, and wherein the first membrane comprises a porous polymer; and
limiting a membrane temperature of the first membrane to less than a first membrane softening temperature during absorption of impurities.

15. The method of claim 14 wherein limiting the membrane temperature of the first membrane comprises limiting the membrane temperature of the first membrane to about 80 degrees centigrade or less.

16. The method of claim 14 further comprising:
Absorbing impurities from the gaseous stream into the absorption solution in a second membrane contactor, wherein the absorption solution flows from the second membrane contactor to the first membrane contactor; and
Cooling the absorption solution between the second membrane contactor and the first membrane contactor in a third membrane contactor, wherein the gaseous stream bypasses the third membrane contactor

17. The method of claim 16 wherein cooling the absorption solution between the second membrane contactor and the first membrane contactor comprises feeding a contactor cooling stream through the third membrane contactor.

18. The method of claim 14 further comprising:
absorbing impurities from the gaseous stream into the absorption solution in a second membrane contactor, wherein the gaseous stream flows from the first membrane contactor to the second membrane contactor and wherein the absorption solution flows from the second membrane contactor to the first membrane contactor.

19. The method of claim 18 wherein limiting the membrane temperature of the first membrane to less than the first membrane softening temperature comprises cooling the absorption solution in an absorption solution heat exchanger between the second membrane contactor and the first membrane contactor.

20. An apparatus for removing impurities from a gaseous stream, the apparatus comprising:
a first membrane contactor comprising a first membrane, a first gaseous stream inlet, a first gaseous stream outlet, a first absorber solution inlet, and a first absorber solution outlet;
a second membrane contactor comprising a second membrane, a second gaseous stream inlet, a second gaseous stream outlet, a second absorber solution inlet, and a second absorber solution outlet, wherein the first gaseous stream outlet is coupled to the second gaseous stream inlet; and
an absorption solution heat exchanger coupled to the second absorber solution outlet and the first absorber solution inlet.
